(19) United States
(12) Patent Application Publication
(10) Pub. No.: US 2006/0095230 A1
(43) Pub. Date: May 4, 2006

(54) Method and system for enhancing machine diagnostics aids using statistical feedback

(76) Inventors: Jeff Grier, Royal Oak, MI (US); James J. Cancilla, San Jose, CA (US); Sunil P. Reddy, Corpus Christi, TX (US); Dale A. Trsar, Mt. Prospect, IL (US); Bradley R. Lewis, Gilroy, CA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/980,206

(22) Filed: Nov. 2, 2004

(51) Int. Cl. G21C 17/00; G06F 11/30

(52) U.S. Cl. 702/183

(57) ABSTRACT

A system and method for improving diagnostic aids such as fault trees and repair manuals uses feedback in the form of repair data from a distributed base of data collection devices used by technicians. The data is processed by a data analysis computing unit. The computing unit determines proposed modifications to the diagnostic aid based on the data. A diagnostic tool editor is used by a subject matter expert to review the proposed modifications and either accept, reject, or modify the diagnostic aid. The modified aids are then made available to the service technicians in the field, improving their efficiency and ability to more quickly diagnose machine conditions. The disclosure is applicable to machines generally, including for example automobiles or components thereof, such as engines and transmissions.

### RELATED APPLICATION

This application is related to a co-pending application filed ______, of Jeff Grier et al., entitled PRIORITIZED TEST PROCEDURE AND STEP DISPLAY USING STATISTICAL FEEDBACK, Ser. No. ______, the entire contents of which are incorporated by reference herein.

### BACKGROUND

This disclosure relates generally to the art of machine diagnostics and repair. More particularly, the disclosure relates to a method and system of improving machine diagnostic tools, such as fault trees, based on statistical feedback from service data from the field. A benefit of the disclosure is that it allows the diagnostic tools to be improved, and thereby allow service technicians to correctly diagnose a problem with the machine more quickly.

A fault tree (sometimes also called a diagnostic tree) is a flow chart in the form of a series of test steps or procedures that guide a technician to diagnose the cause of a malfunction or other condition in a machine. Fault trees are used in diagnosis of many different types of machines, for example a copy machine, a printing press, a refrigerator, a medical diagnostic instrument, a component of an aircraft, or an automobile engine.

Fault trees, and other diagnostic aids such as repair tips, bulletins and the like, are typically prepared by engineers and designers employed by the machine manufacturer. Often, they are printed and distributed at the time the machine is first manufactured and sold commercially for the benefit of field service technicians, or they can be in-house authored. The fault trees typically represent the machine's designer's best estimate of the optimum sequence of test procedures to arrive at a diagnosis of machine fault or error, with a minimum of trial and error. However, the real world experience of technicians in the field sometimes is very different from the predictions and estimations of the machine designers. As such, over the life of the machine the fault trees can become out of date and fail to reflect the real world experience of service technicians in the field.

For example, the machine designer will typically have the first test step in the fault tree calculated to uncover the designer's prediction of the most likely failure or fault given a certain symptom, the second test step to uncover the second most likely fault, etc. However, the technicians in the field may discover, for example, that the fourth test step in the fault tree is more likely to reveal the fault in the machine more than the first or second step, that the fault tree does not contain a step that can lead to a diagnosis, or that the first two steps in the procedure do not reveal the source of the problem most of the time whereas the third through fifth steps are more likely to reveal the source of the problem. Accordingly, in this situation the fault tree is out of step with the experience of the technicians. If the technician follows the fault tree in the order originally specified by the manufacturer, as they are trained to do, they spend valuable time performing diagnostic steps that make no progress towards the diagnosis more often than they should.

The methods of this disclosure provide a way of improving diagnostic tools such as fault trees, and in particular provides a more automated way of examining how often steps in a fault tree are used and how often they result in a correct diagnosis. The methods can be applied to other diagnostic aids, including repair manuals, service bulletins, tips and suggestions for fixing certain problems, and still others.

### SUMMARY

A system is disclosed for improving a diagnostic tool for aiding in machine diagnostics. The diagnostic tool will typically, but not necessarily, take the form of a graphical aid such as a fault tree, diagnostic tip sheet, repair guide, manual or some other form or type that is used by a technician in the field to diagnose a fault or other condition in a machine. The machine can take many possible forms, such as a copy machine, a printing press, a refrigerator, a medical diagnostic instrument, a component of an aircraft, or an automobile engine or other component of a motor vehicle, such as brakes, exhaust system, etc. In other words, the disclosure is of broad, general applicability.

The system includes a plurality of distributed data collection mechanisms or devices adapted for collecting data from a plurality of distributed machines, e.g., devices used in repair shops or service centers over a wide area such as state, region or even the entire United States. The data collection devices are typically, but nut necessarily, computer-based tools that are used to diagnose faults or other conditions in a machine. These data collection devices acquire diagnostic session data during a repair or service session on the machine, such as fault codes, wear readings, machine settings, resistance values, temperature readings, clearances or tolerances, type of fault tree used and steps of fault tree entered, results of use of each step or module, and other types of data. The type of data collected will depend on the particular machine or component part under consideration. In an automotive example, the data may consist of for example fault codes, data from exhaust sensors, engine idle conditions (rough, smooth, etc.), spark plug condition or gap, coolant temperature readings, valve clearance or condition, etc.

The data collection devices in illustrated embodiments periodically forward repair session data to a central location. The data is processed as described herein at the central location, where it is used to modify the diagnostic tool or aid, as described in further detail. The data collection device could have a network interface for transmission of the session data over a communications network such as the Internet or telephone network. Alternatively, the session data could be provided to the central location in numerous other manners, such as by mailing a computer disk containing session data, by fax, by telephone, by typing into a form on a computer and sending the form as an email attachment, or by some other method, the details are not important.

The system further includes a central data analysis engine, preferably in the form of a programmed computing unit. The computing unit performs at least one processing operation on the data received from the plurality of distributed data collection devices and generates at least one proposed modification to the diagnostic tool based on the data. The data analysis unit may use statistical analysis techniques, simple counting, weighting or ranking techniques, or some other processing which will be evident from this disclosure. The point of the processing is to use the repair data as a feedback mechanism to improve the quality of the diagnostic tool based on the experience of technicians in the field (or, more precisely, based on the actual diagnostic data received from the distributed data collection devices). In other words, based on the results of the data analysis, the data analysis unit recommends substantives modifications to the diagnostic tool. For example, where the diagnostic tool is a diagnostic fault tree, the analysis unit may propose a modification to either the content of individual steps in the fault tree, or the sequence of actions or steps in the fault tree. As another example, the analysis unit could propose an additional step or test in a fault tree. As another possible example, the analysis unit could propose a modification to a repair sheet for diagnosing fixing a particular problem, based on the statistical feedback from many other repair shops servicing the same machine.

The system further includes a diagnostic tool editor comprising a set of instructions executable by a programmed machine. The programmed machine could be the machine embodying the data analysis unit, or it could be a separate machine (e.g., a workstation). The editor includes set of instructions allowing a user to (a) view the at least one proposed modification to the diagnostic tool generated by the data analysis unit and (b) selectively accept, modify or reject the proposed change. At the end of the review, any changes are stored in a new version of the diagnostic tool and incorporated into new versions of the diagnostic tool. The new and improved diagnostic tool is then typically distributed to service units in the field, or made available on-line.

Thus, it can be seen that using the feedback from a distributed arrangement of data collection devices, and using the processing features of this disclosure, it is possible to develop a substantial knowledge base of machine diagnostic and repair information, based on actual field experiences, and to actively use such information to improve diagnostic tools such as fault trees and other types of aids. Such information, and the diagnostic tools based on such tools, are almost always lacking when repair guides or fault trees are developed in prior art methods. The methods and systems of this disclosure thus present a way of improving the diagnostic process and tools used in machine diagnostics as compared to prior art techniques.

The illustrated embodiments are particularly useful for updating or improving diagnostic aids that are capable of being represented in a graphical form. Examples include diagnostic fault trees, troubleshooting guides, and a repair guide. The system could also be used for improving the design of hard tools such used in diagnostics, including the data collection devices themselves.

While in one embodiment of this disclosure an entire system is envisioned including the distributed data collecting devices, central data analysis engine or computing unit, and a diagnostic tool editor. The system can also be considered as consisting of just the central data analysis computing unit and the associated diagnostic tool editor; i.e., the devices that are used to process service data and generate updated, revised diagnostic tools. In this embodiment, the central data analysis computing unit performs at least one processing operation on machine diagnostic data received from a plurality of distributed data collection devices. The central data analysis computing unit is programmed to generate at least one proposed modification to a diagnostic tool based on the data. The diagnostic tool editor includes a set of instructions executable by a programmed machine, the instructions allowing a user to (a) view the at least one proposed modification to the diagnostic tool and (b) selectively accept, modify or reject the proposed change.

Yet another aspect of the disclosure is a method for updating a diagnostic tool for aiding in machine diagnostics. The method includes the step of receiving diagnostic session data from a plurality of distributed data collection devices and storing the diagnostic session data in a memory. The method further includes a step of processing the diagnostic session data with a programmed machine and responsively generating a proposed modification to the diagnostic tool based on the diagnostic session data. The method further comprises a step of providing a diagnostic tool editor, wherein the editor is programmed to present the diagnostic tool to a user and allow the user the interactively accept or reject the proposed modification.

In one possible embodiment, the processing step is performed on a periodic basis, e.g., every six months or when a statistically sufficient amount of new data has been sent to the system. This allows modifications to be made in the diagnostic tool on a periodic basis.

Furthermore, it will be appreciated that for any given machine (or sets of different machines of the same class, such as a given automobile engine or all the engines currently made by a particular manufacturer) there may be a large number of diagnostic tools that exist. The process of data collection, data analysis, and generation of proposed modifications to a given diagnostic tool will typically be occurring simultaneously in parallel. As such, the data analysis aspects of this method are preferably programmed to occur automatically in the data analysis computing unit.

Further details regarding these and other features of the disclosure will be found by reference to the following detailed description and by reference to the appended drawing figures.

### BRIEF DESCRIPTION OF THE DRAWINGS

FIG. 1 is an illustration of a system for improving machine diagnostics, including a host system that generates a fault tree and other diagnostic data, and a shop where the fault tree is used to diagnose a malfunction in a machine, the machine being an automobile engine or component thereof.

FIG. 2 is an illustration of a representative, typical fault tree for diagnosing a particular type of ailment for the machine of FIG. 1, showing three sets of numbers assigned to each test module or node in the fault tree.

FIG. 3 is a detailed illustration of a block of memory representing an arbitrary test procedure or module in the fault tree of FIGS. 2 and 3.

FIG. 4 shows a revision to the fault tree of FIG. 2, which would result from the use of the statistical feedback features of this disclosure.

FIG. 5 is a block diagram showing a central data collection and processing system that generates updated diagnostic trees or other diagnostic aids based on feedback from repair or service sessions.

FIGS. 6A and B are a flow chart explaining the steps used in generating updated diagnostic aids using the system of FIG. 4

### DETAILED DESCRIPTION

This disclosure provides a method and system for improving a diagnostic tool for aiding in machine diagnostics, for example updating and prioritizing test procedures such as a fault tree using statistics or feedback from technicians in the field. By following the features of the present method, improved diagnostic tools can be developed. A benefit is that the technicians work more efficiently and can arrive at the correct diagnosis of a machine fault more quickly.

While an embodiment is described herein in the context of automobile repair and diagnosis, the methods and system are broadly applicable to any machine or system that uses diagnostic tools or aids (typically graphical tools such as a fault tree) to guide a technician in uncovering the source of a fault or other condition in a machine.

The system includes a plurality of distributed data collection mechanisms or devices adapted for collecting data from a plurality of distributed machines, e.g., devices used in repair shops or service centers over a wide area such as state, region or even the entire United States. The data collection devices are typically, but nut necessarily, computer-based tools that are used to diagnose faults or other conditions in a machine. In an automotive example, the data collection devices could take the form of integrated testing, diagnostic and information instrument such as the MODIS system available from Snap-On Technologies, hand-held or laptop computer type diagnostic tools, or equivalent systems and devices from other vendors. These data collection devices acquire diagnostic session data during a repair or service session on the machine, such as fault codes, wear readings, machine settings, resistance values, temperature readings, clearances or tolerances, and other types of data. The type of data of course will depend on the particular machine or component part under consideration. In an automotive example, the data may consist of for example fault codes, data from exhaust sensors, engine idle conditions (rough, smooth, etc.), spark plug condition or gap, etc.

The data collection devices in illustrated embodiments periodically forward repair session data to a central location. The data is processed as described herein at the central location, where it is used to modify the diagnostic tool or aid, as described in further detail. The data collection device could have a network interface for transmission of the session data over a communications network such as the Internet or telephone network. Alternatively, the session data could be provided to the central location in numerous other manners, such as by mailing a computer disk containing session data, by fax, by telephone, by typing into a form on a computer and sending the form as an email attachment, or by some other method, the details are not important.

The system further includes a central data analysis computing unit. This unit performs at least one processing operation on the data received from the plurality of distributed data collection devices and generates at least one proposed modification to the diagnostic tool based on the data. The data analysis unit may use statistical analysis techniques, simple counting, weighting or ranking techniques, or some other processing which will be evident from this disclosure. The point of the processing is to use the repair data as a feedback mechanism is improve the quality of the diagnostic tool based on the experience of technicians in the field (or, more precisely, based on the actual diagnostic data received from the distributed data collection devices).

One example of the processing is described below in which the processing takes the form of calculating confidence scores and using the confidence scores to rank nodes or steps in a fault tree and preparing a proposed revised edition of a fault tree based on the confidence scores. In other words, based on the results of the data analysis, the data analysis unit recommends substantive modifications to the diagnostic tool. For example, where the diagnostic tool is a diagnostic fault tree, the analysis unit may propose a modification to either the content of individual steps in the fault tree, or the sequence of actions or steps in the fault tree. As another example, the analysis unit could propose an additional step or test in a fault tree. As another possible example, the analysis unit could propose a modification to a repair sheet for diagnosing fixing a particular problem, based on the statistical feedback from many other repair shops servicing the same machine.

The system further includes a diagnostic tool editor comprising a set of instructions executable by a programmed machine. The programmed machine could be the machine embodying the data analysis unit, or it could be a separate machine (e.g., a workstation). The editor includes set of instructions allowing a user to (a) view the at least one proposed modification to the diagnostic tool generated by the data analysis unit and (b) selectively accept, modify or reject the proposed change. The user will typically be a subject matter expert that is involved in the creation of the diagnostic tools, and thus will apply their experience and judgment on whether to accept the proposed modification, modify it (either substantively or editorially) or reject it.

In a typical embodiment, proposed modifications are stored by the editor as provisional changes, and a notification is sent to the appropriate subject matter expert that there is an updated diagnostic tool (e.g., diagnostic fault tree) available for review. As part of his normal work process, the expert will utilize the editor to review the changes proposed by the data analysis unit and selectively accept or reject the proposed changes. At the end of the review, any changes are stored in a new version of the diagnostic tool and incorporated into new versions of the diagnostic tool. The new and improved diagnostic tool is then typically distributed to service units in the field, or made available on-line.

Thus, it can be seen that using the feedback from a distributed arrangement of data collection devices, and using the processing features of this disclosure, it is possible to develop a substantial knowledge base of machine diagnostic and repair information, based on actual field experiences, and to actively use such information to improve diagnostic tools such as fault trees and other types of aids. The methods and systems of this disclosure present a way of improving the diagnostic process and tools used in machine diagnostics as compared to prior art techniques.

The illustrated embodiments are particularly useful for updating or improving diagnostic aids that are capable of being represented in a graphical form. Examples include diagnostic fault trees, troubleshooting guides, and a repair guide. The system could also be used for improving the design of hard tools such used in diagnostics, including the data collection devices themselves.

Yet another aspect of the disclosure is a method for updating a diagnostic tool for aiding in machine diagnostics. The method includes the step of receiving diagnostic session data from a plurality of distributed data collection devices and storing the diagnostic session data in a memory. The method further includes a step of processing the diagnostic session data with a programmed machine and responsively generating a proposed modification to the diagnostic tool based on the diagnostic session data. The method further comprises a step of providing a diagnostic tool editor, wherein the editor is programmed to present the diagnostic tool to a user and allow the user the interactively accept or reject the proposed modification.

In one possible embodiment, the processing step is performed on a periodic basis, e.g., every six months or when a statistically sufficient amount of new data has been sent to the system. This allows modifications to be made in the diagnostic tool a periodic basis.

Furthermore, it will be appreciated that for any given machine (or sets of different machines of the same class, such as a given automobile engine or all the engines currently made by a particular manufacturer) there may be a large number of diagnostic tools that exist. The process of data collection, data analysis, and generation of proposed modifications to a given diagnostic tool will typically be occurring simultaneously in parallel. As such, the data analysis aspects of this method are preferably programmed to occur automatically in the data analysis computing unit.

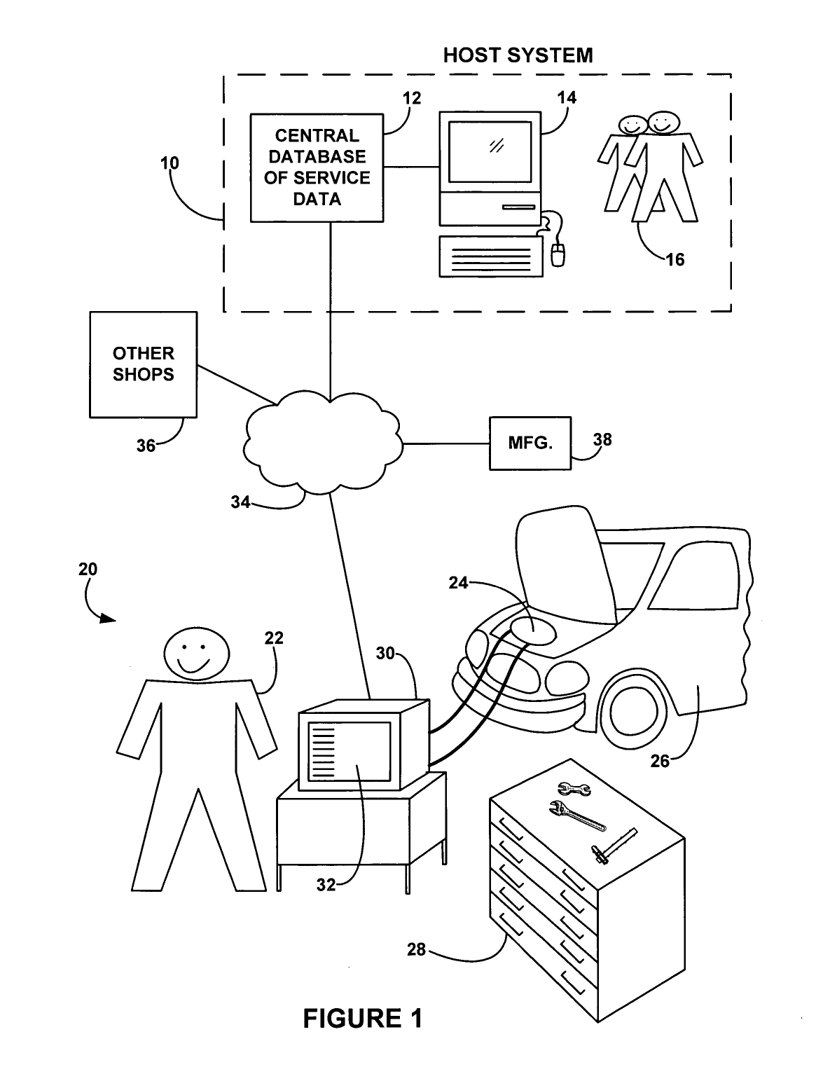

Referring now to FIG. 1, a system 10 is shown for receiving service data from distributed data collection devices, processing the service data and generating proposed modifications to diagnostic aids based on the service data in a feedback arrangement. The system 10 is shown as a centrally located host system that is typically present at either the site of the manufacturer of the machine or, alternatively, an entity that is in the business of compiling service data and generating diagnostic aids to assist in diagnosis of machine conditions for a distributed base of service technicians. The system 10 includes a central database 12 that receives and stores service data from service technicians 20 and data collection devices 30 in the field. The central database 12 can take the form of commercially available database and associated software and workstations, such as provided by Oracle Corporation, IBM or other database provider. The service data stored in the database could include information such as the make and model of the machine, the symptom that prompted the service occasion, the fault tree or other diagnostic aid that was used by the technician, the modules or steps of the fault tree that were accessed, the result of the testing on each module, the ultimate diagnosis, machine conditions, etc. that were recorded during the service (e.g., failure codes, temperatures, wear readings, etc.), the repairs made, notes or comments from the technician; other repairs made, etc.

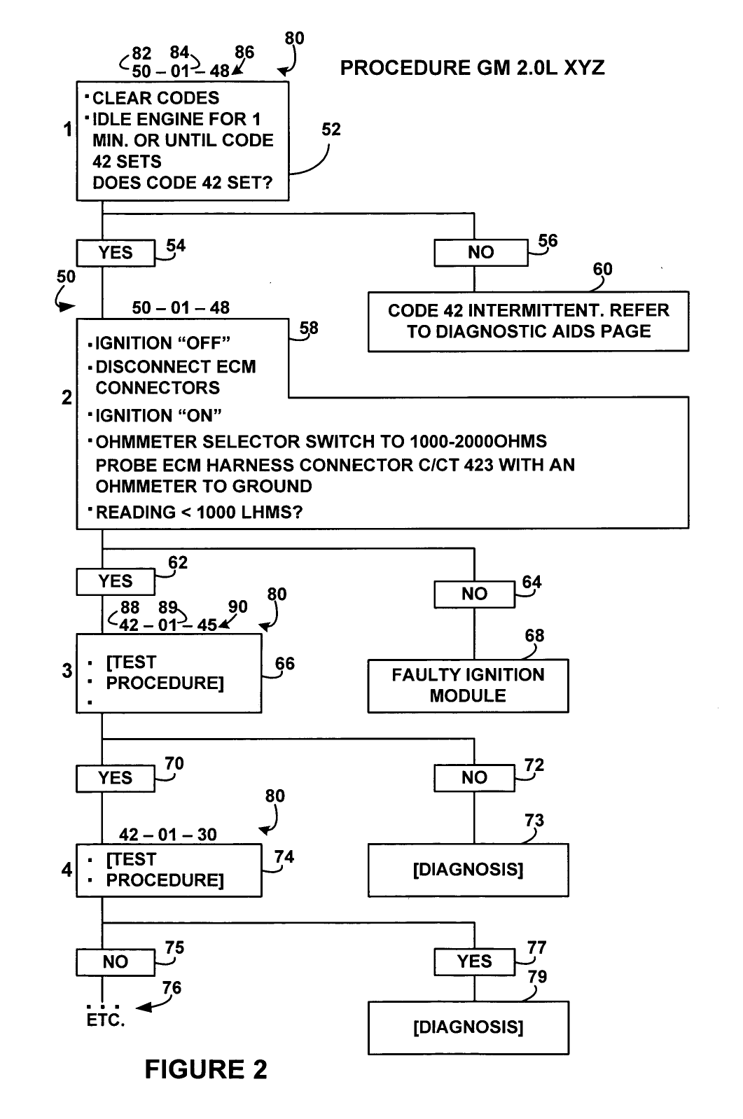

The host system 10 also includes a central data analysis engine or computing unit, shown in the figure as a general purpose computer workstation 14. The manner in which the data analysis engine or computing unit is embodied is not particularly important, and can take the form of a special purpose computing system, general purpose computing system, main frame computer, attached peripheral devices such as memories, or a network of computers. The workstation 14 accesses the service session data in the database 12. The workstation 14 includes a memory that stores various diagnostic aids, such as bulletins, manuals, fault trees, etc., including the fault tree of FIG. 2.

The system further includes a diagnostic tool editor comprising a set of programmed instructions (i.e., software) executable by a programmed machine. The programmed machine could be the machine or workstation 14 embodying the data analysis computing unit, or it could be a separate machine, e.g., any workstation on a local area network at the host system 10 that is used for the purpose of providing human review, creation and editing of diagnostic aids. The editor includes set of instructions allowing a user to (a) view the at least one proposed modification to the diagnostic tool generated by the data analysis unit 14 and (b) selectively accept, modify or reject the proposed change. The user will typically be a subject matter expert 16 that is involved in the creation of the diagnostic tools, and thus will apply their experience and judgment on whether to accept the proposed modification, modify it (either substantively or editorially) or reject it.

The experts 16 may, for example, access the service data stored in the central database 12 and run statistical analysis applications on the data to determine which modules in a given fault tree have been accessed, and the results that are obtained from the technicians using the modules. The experts 16 may also create initial confidence scores for the modules, revise the confidence scores, create new fault trees based on the revised confidence scores, or create new diagnostic tools such as new repair bulletins or repair tip sheets.

Alternatively, some or all of these functions may be automated by appropriate software algorithms executing on the workstation 14. These algorithms, which can be developed by persons skilled in the art from the present disclosure, could determine that, over a given period of time such as six months, a suitable number of service occasions to be statistically significant, say 100, have occurred and that the service data for these occasions are present in the database 12. The algorithm then checks to see which modules have been accessed in these service occasions and the result of the use of the modules. The algorithm then ranks the modules in accordance with the number of times that the module resulted in the correct diagnosis. For example, for a given fault tree XYZ, it could determine that module number 3 in the fault tree XYZ was more likely to lead to a successful diagnosis than module 2, but module 3 has a lower confidence score. Accordingly, the computer reassigns confidence scores such that module 3 is ranked higher than module 2. The algorithm then could reorder the sequence of the modules in the fault tree from highest number of successful occurrences to the lowest number, and then proposes a new fault tree based on the revised sequence.

The expert uses the editor feature to view the proposed modification to the diagnostic tool and either accept, reject or modify the proposed modification. The revised diagnostic tool is then stored in memory and preferably made available to the service technicians in the field. The date of the creation of the revised fault tree is recorded, the identification numbers for the service occasions used to create the revised fault tree are recorded, and the algorithm then proceeds to process the data associated with another fault tree. In a typical scenario, this process is occurring in parallel, on a periodic basis, for all the fault trees that may be pertinent to the given machine or machines that are of interest to the host system 10.

In the situation of FIG. 1, the service data are obtained from a set of distributed data collection devices located in distributed service facilities, in the present example service and repair shops 20 servicing automobiles. The technicians 22 are servicing machines, which in the present example are engines 24 in passenger cars 26, light trucks and other vehicles. The technicians have diagnostic and repair tools 28 available to them. In one typical example, the tools include a data collection device in the form of a computer-based diagnostic and repair instrument 30 that hooks up to the computers in the engine 24. The instrument 30 includes a screen display 32 which provides a graphical display of machine conditions, meters for testing individual components, a memory storing diagnostic aids such as fault trees or repair tips, and a display for displaying a fault tree and associated photographs or illustrations to assist the technician in performing a diagnosis of a fault or other condition in the engine 24.

While the service data used in the present system can be acquired manually by the technician and input into a computer in the shop and transmitted to the host system 10 (in which case the data collection device can be considered to be the computer in the shop), in other embodiments the service data are obtained by the computer-based diagnostic tool 30 and send directly from the data collection device 30 to the central location 10, e.g., after hours or when the data collection device 30 is not in use. A system such as the MODIS system referenced earlier, or the system described in U.S. Pat. No. 6,714,816 to Trsar et al., “Diagnostic Director”, the contents of which are incorporated by reference herein, are examples of a suitable computer-based diagnostic system suitable for use as a service data collection device. It will be appreciated that in other industries, other types of devices may be used to collect and record service data, and that manner or device used to collect service data and transmit the service data to the host system 10 is not particularly important. Examples of other devices that could be used in the automobile context are the portable service technician computer disclosed in U.S. Pat. No. 5,533,093, the computer based technician terminal disclosed in U.S. Pat. No. 4,796,206, the engine analyzer disclosed in U.S. Pat. No. 5,250,935, the diagnostic computer platform disclosed in U.S. Pat. No. 6,141,608, and the system for diagnosing and reporting failure of emissions tests in U.S. Pat. No. 5,835,871.

In the example of FIG. 1, the service data for the servicing of the car engine 24 are transmitted over a computer or telephone network to host system 10 at a central location using known communications techniques, where it is stored in the database 12. Each service occasion could be assigned a unique identification code or number. A given service occasion for the machine 24 could involve the use of more than one fault tree or other diagnostic tool, depending on the symptoms of the machine and the results of using a given fault tree. The fault tree used by the technician could also take the form of a printed repair manual or service bulletin, or some other form.

It will also be understood that the shop environment 20 may be one of many different shops or sites in which service data are obtained. The other sites or shops are represented by reference 36 in FIG. 1. Also, the system 10 could be coupled to the manufacturer 38 of the engine 24 in order to obtain other data (e.g., service bulletins, new fault trees, repair information, recall information, etc.) from the manufacturer.

FIG. 2 is an example of a hypothetical diagnostic aid or tool in the form of a fault tree 50, with the title GM 2.0L XYZ, that can be used and updated according to the features of this disclosure. Assume for the purposes of this example that the fault tree is an ignition system fault tree for a General Motors 2.0 liter engine. The fault tree 50 is a flow chart in the form of a series of test steps or procedures 52, 58, 66, 74, 76 that a technician uses to diagnose the cause of a malfunction or other condition in a machine. The machine could be any kind of machine, for example a copy machine, a printing press, a refrigerator, a medical diagnostic instrument, a component of an aircraft, or an automobile engine in the example of FIG. 2. The fault tree 50 is typically prepared for service technicians by the machine's manufacturer. Fault trees are typically published in repair or service manuals for the machine. They may also be available on-line and accessed by a technician over the Internet using a computer, or stored and displayed on the data collection device 30.

In the example of FIG. 2, the first module 52 includes a series of actions or steps and the module asks whether a certain condition is met (“Does code 42 set?”). If the answer is yes as indicated at 54, the fault tree proceeds to step 58. If no (block 56), a diagnosis is presented at block 60. The second module 58 then proceeds to another series of actions or steps and presents a question to the technician—is a particular resistance reading less than 1000 ohms. If so (block 62) the next test procedure 66 is invoked. If no (block 64), a diagnosis is made at block 68 (faulty ignition module). As is evident from FIG. 2, the fault tree includes other steps shown as 70, 72, 73, a fourth test procedure 74 another set of yes/no blocks 75 and 76, another possible diagnosis 79, and still further steps 76. The details of course are not important.

Each of the test modules 52, 58, 66, 74 is assigned a set of three numbers or attributes 80 in the illustrated embodiment. The first number in the set of three numbers is the number of times the particular test modules has been entered. The first number (82, 88 in FIG. 2) could be on a per shop basis, per technician basis, a system wide basis, or other basis. The second number (84, 89 in FIG. 2) is a technician level index. This number indicates the level of technician that the procedure or module is displayed to. For example, an index of 01 is associated with an expert technician level. An index of 02 could be associated with an apprentice or entry level technician. If the technician is an expert, then some modules in the fault tree may be omitted from the fault tree since the experts would instinctively perform the test procedure without any prompting. These attributes, such as the number of entries, and the index of technician level, would typically be presented to the experts 16 at the host system 10 while they are editing a fault tree. The attributes may or may not be provided to end users that access the fault tree.

The third number (86, 90 in FIG. 2) is a confidence score that is assigned to the test module. The confidence score, which may be assigned a numerical value (e.g., from 1 to 100), is a value or index that represents a ranking or probability that the associated test module will lead to a correct diagnosis of the machine fault or condition. For example, a test module with the highest confidence score among all the modules in the fault tree is one in which is most likely to result in a successful diagnosis, and thus would be listed first in the sequence of modules forming the fault tree. A test module with a low confidence score would be one that is rather unlikely to lead to the correct diagnosis, and thus should be listed in the test sequence after test modules with higher confidence scores.

In the example of FIG. 2, the first module 52 has a confidence score of 50. The second module 58 has a confidence score of 48. The third module 66 has a confidence score of 45. The fourth module 74 has a confidence score of 30. Thus, the modules are arranged in a sequence with the first module having the highest confidence score, the second module having the second highest confidence score, etc.

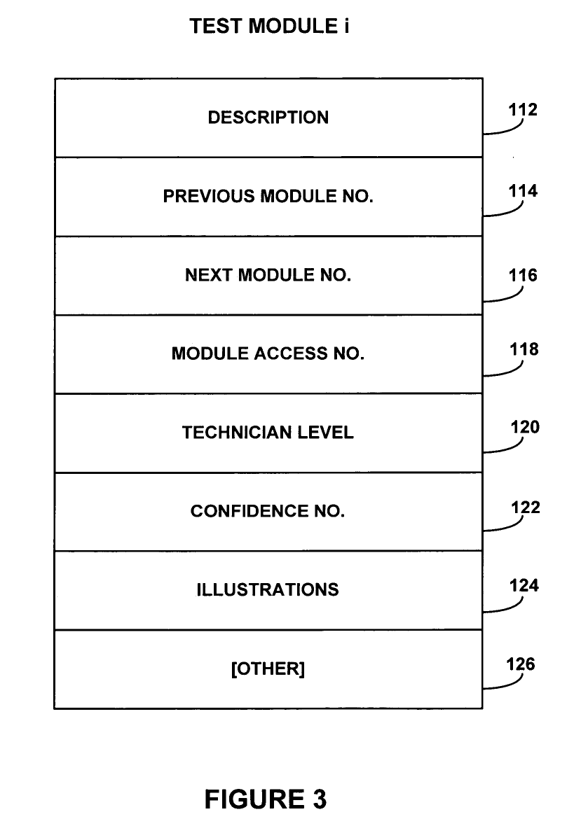

The GM 2.0L XYZ fault tree 50 can be stored in the database 12 of FIG. 1 or equivalently in the memory of the workstation 14 as a set of blocks of memory. As shown in FIG. 3, each block of memory 110 for a given test module includes a number of different fields of memory, including a description field 112, a field 114 identifying the previous module in the sequence of the fault tree, a field 116 identifying the next module in the sequence, a field 118 containing a number indicating the number of times the module has been accessed (the first set of numbers in the set 80 of FIG. 2), a field 120 indicating a technician level in which the module is displayed in the fault tree, a field 122 containing a confidence score for the module, a field 124 containing illustrations or photographs associated with the module (or links to such illustrations or photographs), and other fields 126, which could contain other data such as notes from technicians or service experts, outputs of the module, diagnosis, identification of subject matter expert at the host system, or other information.

One of the features of this disclosure is that the fault tree of FIG. 2 is updated and prioritized using statistical feedback from technicians in the field. By following the features of the present method, improved fault trees can be developed. A benefit is that the technicians work more efficiently and more likely to arrive at the correct diagnosis of a machine fault quickly than they otherwise would.

As noted above, service data is obtained from distributed data collection devices for a plurality of service occasions for like machines. The service data could be obtained from a plurality of geographically distributed technicians all servicing the same type of machine. Alternatively, the service data could be obtained from multiple technicians in the same repair facility. The service data could include information such as the make and model of the machine, the symptom that prompted the service occasion, the fault tree that was used, the modules of the fault tree that were accessed, the result of the testing on each module, the ultimate diagnosis, machine conditions that were recorded during the service (e.g., failure codes, temperatures, wear readings, etc.), the repairs made, notes or comments from the technician; other repairs made, etc. The service data can be acquired manually and input into a computer and transmitted to the host system 10 where the method is executed; alternatively the service data could be obtained by a computer-based diagnostic tool or system such as the MODIS system or the system described in U.S. Pat. No. 6,714,816 to Trsar et al.

When a statistically significant amount of new service data is present in the database 12, the data analysis engine or computing unit in the workstation 14 then performs a processing step on the data and generates a proposed modification to the diagnostic aid. One example which will be described here is processing the data to generate new confidence scores for the individual nodes in the fault tree and generate a proposed new fault tree based on the revised confidence scores (essentially re-ordering the steps in the fault tree). As another example, the sequence of the steps in the fault tree could remain the same but the content or test procedures in one or more steps could change.

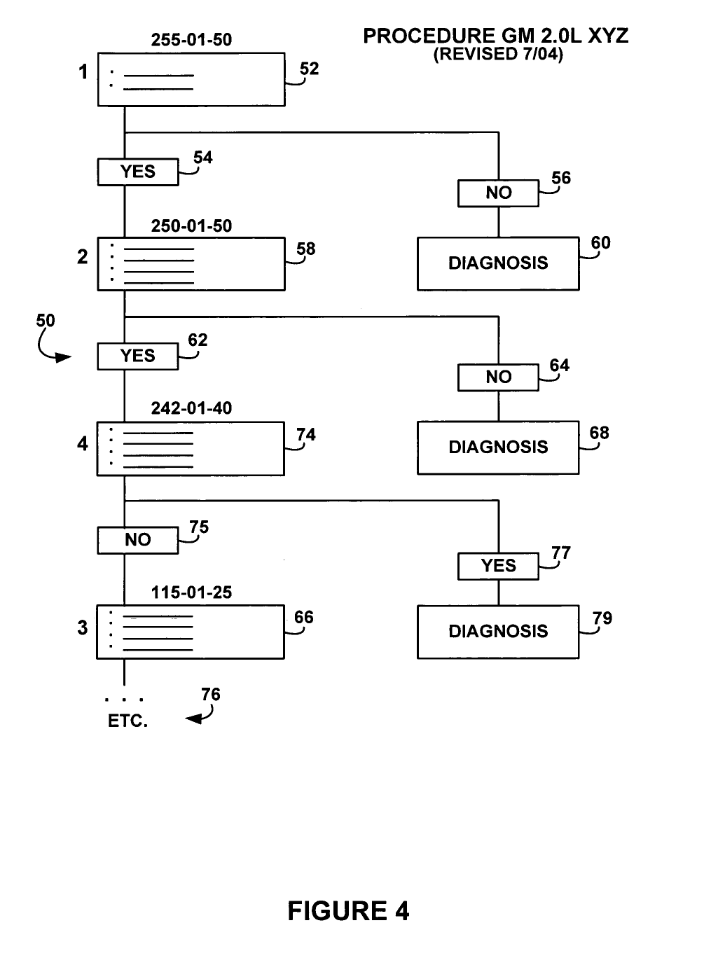

In the example of the use of confidence scores, the processing includes the step of revising the confidence scores 86, 90 for at least one test module in the fault trees, based on the service data. This step could be performed by a human operator based on their expert evaluation of the service data, or automatically by a programmed computer executing an algorithm that processes fields in the service data. For example, the computer could determine that, over a given period of time such as six months (provided that there is a suitable number of service occasions to be statistically significant, say 100), module number 4 (74) in the fault tree GM 2.0 L XYZ (50) was more likely to lead to a successful diagnosis than module 3 (66) but module 4 has a lower confidence score, the situation shown in FIG. 2. Accordingly, the computer reassigns confidence scores such that module 4 (74) is ranked higher than module 3. Thus, as shown in FIG. 4, after processing the service data in the database 12, the module 4 (74) has been assigned a confidence score of 40 (increasing it from 30 in FIG. 2), and module 3 (66) has been assigned a confidence score of 25 (decreasing it from 45 in FIG. 2).

The processing performed by the workstation 14 then includes a step of generating a proposed modification to the diagnostic aid, in this example the proposed modification is revising the sequence of the test modules in the fault tree based on the revised confidence score(s). This is shown in FIG. 4. The algorithm proceeds to process each of the blocks of memory shown in FIG. 3, changes the confidence score field 122, and changes the ordering or sequence by changing the fields 114 and 116 to re-order the sequence of modules in the fault tree.

The system includes the diagnostic tool editor (e.g., software executing on the workstation) which is used by a subject matter editor to review the proposed modification. The proposed revised fault tree is displayed on the workstation 14 of FIG. 1 using the editor. Continuing the above hypothetical example, the data analysis computing unit revises the fault tree such that module 4 (74) is listed in the fault tree before module 3 (66). The subject matter expert 16 can accept the change, reject the change, or modify it, either substantively or editorially.

Assuming that the change is accepted by the expert, and that statistically significant sampling of service data is available and used to revise the confidence stores (a situation that can be controlled by only allowing the algorithm to execute when there is a sufficiently large number of service occasions uploaded into the database), and assuming that the technician has access to and uses the revised fault tree of FIG. 4, a technician following the revised fault tree is more likely to arrive at a correct diagnosis in a shorter amount of time than he otherwise would have had he used the previous version fault tree. Thus, in general and as a matter of statistical probability, the revised fault tree allows the technician to work more efficiently.

The revised fault trees or other diagnostic aids generated using this disclosure can be distributed to technicians in the field in any number of ways, including delivering hard copies of repair manuals, fault trees or other aids, delivering computer disks containing repair information and the updated diagnostic aids, sending the revised diagnostic aids as attachments to electronic mail, or by posting the revised diagnostic aids as a file on an central server that the technicians access over a computer network (e.g., a local or wide area network, e.g., Internet), a telephone line, or wireless networking technique.

The individual modules in the fault tree may have other attributes in addition to confidence scores, such as a numerical value indicating the number of times a test module in a fault tree was entered or accessed. This number may be useful in factoring into whether or not a change in the confidence score is indicated. For example, if a particular module in a fault tree was hardly ever entered but other modules are much more frequently entered into, the module with the low numerical value for entry probably should not have a high confidence score and may even be omitted from the fault tree entirely.

As another example, a test module can have an additional attribute assigned to it in the form of an index or numerical value indicating the technician level that the module would be displayed to. For example, if the technician is an expert, then some modules in the fault tree may be omitted from the fault tree since the experts would instinctively perform the test procedure without any prompting. These attributes, such as the number of entries, and the index of technician level, would typically be presented to the subject matter experts at the host system while they are editing the fault tree using the diagnostic tool editor. The attributes may or may not be provided to end users that access the fault tree.

Further, while the illustrated embodiment shows a process for revising one fault tree, it will appreciated that, for any given machine (such as the GM 2.0L engine), the process may be going on in parallel for all of the diagnostic aids that exist for that machine. In the example of a service entity or host system 10 that provides diagnostic aids for the automobile repair industry in the United States, this process may be going on in parallel for literally thousands of fault trees, covering the year, make and model of diverse car manufacturers since 1980 and the various ailments and repair procedures for each of the individual models. In this situation, and in other analogous situations, computer automation of the processing of data in the central database, and generating proposed modification to diagnostic aids as disclosed herein is particularly advantageous. Additionally, the workstation 14 could be programmed to perform these tasks periodically, such as yearly, or periodically based on the number of service occasions, such as every 100 service occasions or every 1000 service occasions.

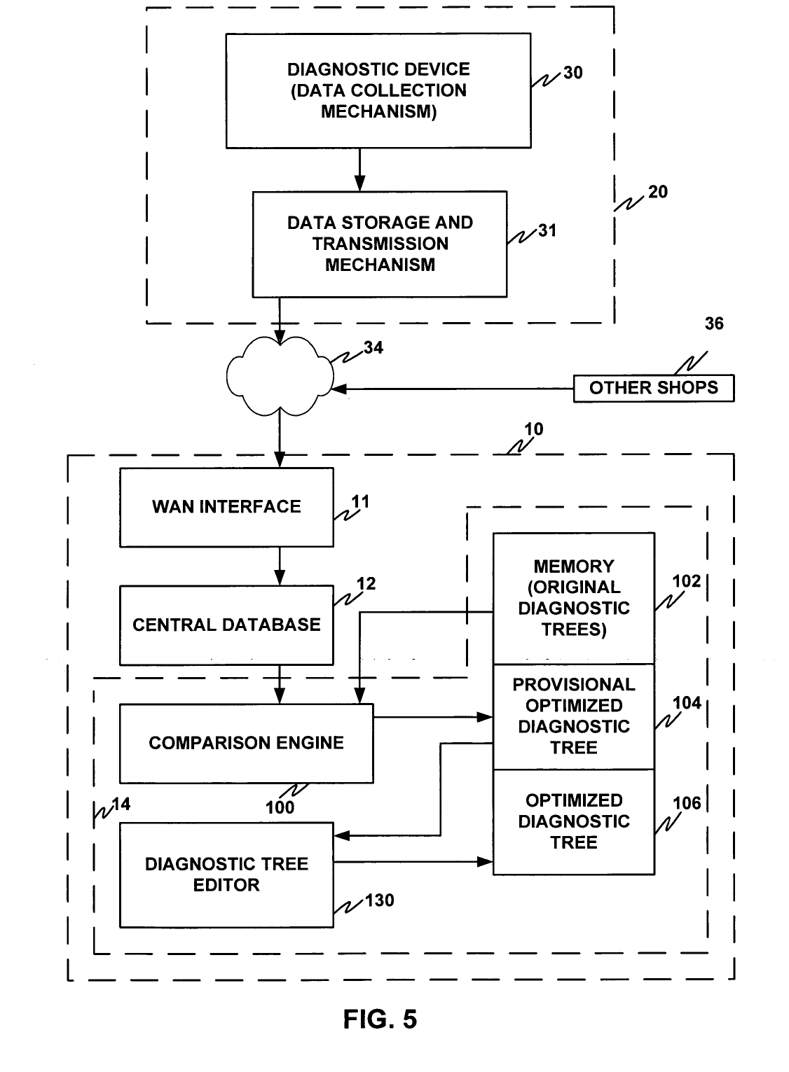

FIG. 5 is a block diagram showing another embodiment of a central data collection and processing system that generates updated diagnostic trees or other diagnostic aids based on feedback from repair or service sessions. A service location 20 for a given machine includes a data collection mechanism 30 that will typically but not necessarily take the form of a diagnostic device. The data collection mechanism obtains data from a repair session (fault codes, wear readings, fault trees used and results from each module accessed, resistance readings, exhaust gas readings, etc.). The data could be collected entirely automatically by the mechanism 30 or could have a user interface to accept data measured or collected by a human. The service location 20 also includes a data storage and transmission mechanism 31 which stores repair data from the data collection device 30 and periodically sends such data over a network 34 to the central or host system 10. The data storage and transmission mechanism could be resident on the data collection mechanism, or could be a separate device such as a general purpose computer and resident memory with Internet access software for uploading repair session data to a central file server or database in the host system 10. The manner in which the data collection mechanism 30 and data storage and transmission mechanism are implemented is not particularly important. Technologies for capturing and storing repair data and transmitting data from one location to another is well known in the art and therefore details are omitted from this discussion for the sake of brevity.

As is noted in FIG. 5, the collection of data typically will involve a plurality of geographically distributed repair or service shops 36 which service machines similar to the machine serviced in the shop 30. For example, the shops 20/36 could be independent repair shops. They could also be shops that are owned or serviced by a common organization, such as service shops for a fleet of aircraft owned by an airlines, or service shops of the United States military where service and repair is conducted for military equipment such as helicopters, light armored vehicles, jet fighters or ships.

The host system 10 has a wide area network (WAN) interface 11 (e.g., remote access server) that couples the network 34 to a local area network at the host system and related network entities, including a central database 12 where such repair session data is stored and a central data analysis computing unit 14. The central data analysis computing unit 14 could take the form of a general purpose computer or workstation. The central data analysis computing unit 14 includes a comparison engine (100) in the form of computer software coded as machine-readable instructions. The central data analysis computing unit 14 also includes a memory storing original diagnostic fault trees 102, provisional optimized diagnostic fault trees 104, and optimized diagnostic trees 106.

The comparison engine 100 accesses repair session data, executes processing algorithms on repair session data in the central database 12 and the original diagnostic trees (examples of which are described herein) and, based on the statistics of the session data prepares provisional optimized diagnostic trees which are stored in memory. The central data analysis computing unit 14 also includes a diagnostic tree editor 130 which comprises a set of software instructions allowing the human experts of FIG. 1 to access the provisional optimized diagnostic fault trees, review and edit them, and approve them for storage as optimized fault trees 106.

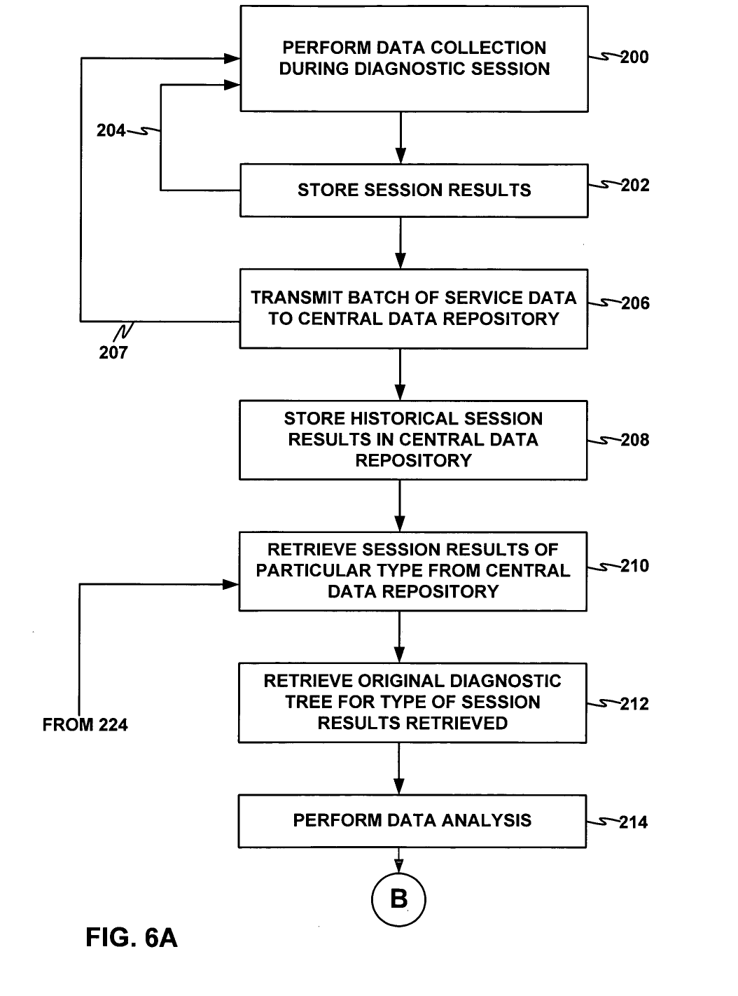

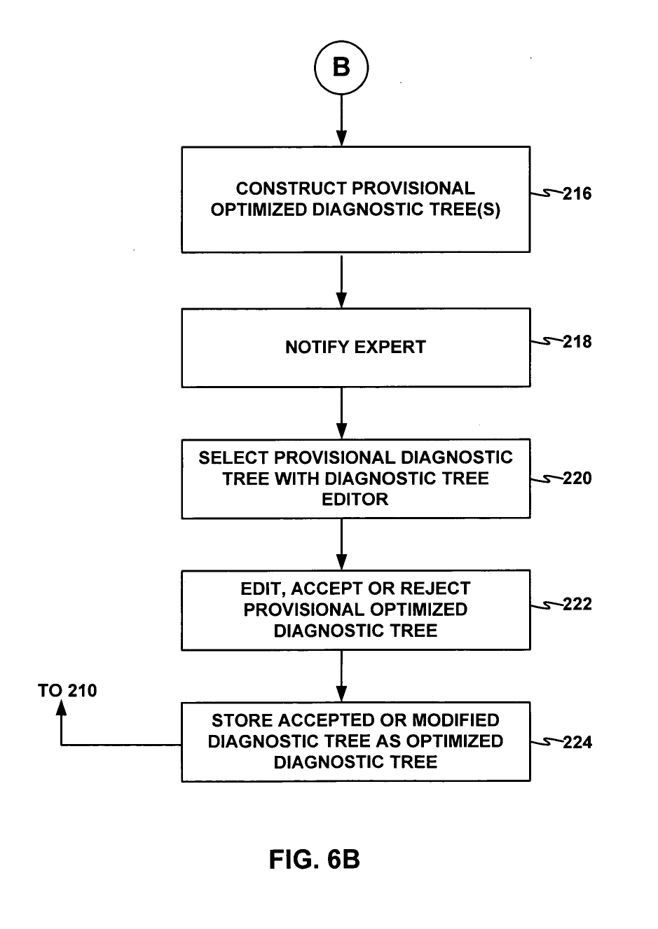

FIGS. 6A and B are a flow chart explaining the steps used in generating updated diagnostic aids using the system of FIG. 5. Referring to these Figures, at step 200, data collection is performed in the distributed repair shops during diagnostic or repair sessions using the data collection mechanism 30 of FIG. 5. At step 202, the session data 202 is stored in the data storage mechanism 31 of FIG. 5. This process typically but not necessarily loops back and repeats (as indicated at 204), whereby a batch representing multiple repair sessions are stored locally in the data storage mechanism 31.

At step 206, a batch of session data is sent to the central or host system data repository (e.g., the database 12 of FIG. 5). As shown at 207, the steps 200, 202, 204 and 206 repeat indefinitely, whereby new batches of session data are repeatedly being sent from the service location 20 to the host system 10. The processes 200, 202, 204, 206 and 207 are also performed by each of the distributed repair or service locations.

At step 208, the historical session data results are stored in the central data repository (database 12).

At step 210, the central data analysis computing unit 14 retrieves session data for a plurality of repair sessions for a particular type or model of machine from the database 12. This step could be performed on a scheduled basis (e.g., once every year or six months), or whenever a statistically significant number of new repair session data has been uploaded into the database 12. This step 210 triggers the data analysis process of the repair data to determine whether modifications need to be made to the diagnostic aids for the type or model of machine, based on the feedback as represented by the repair session data. To perform such data analysis, the original diagnostic trees (102 in FIG. 5) associated with the session data from the memory. At step 214, the data analysis is performed by the comparison engine 100 of FIG. 5. For example, the analysis could look at the results of each diagnostic session in terms of modules used in the original diagnostic tree, the results obtained, and the level of technician for each session, and reassign confidence scores to the modules in the fault tree.

Based on the analysis at step 214, comparison engine 100 constructs a provisional optimized fault tree 104 (FIG. 5) and stores it in memory. At step 218 the subject matter expert for the machine is notified. For example, the fault tree could include a field wherein the fault tree is assigned a subject matter expert (the field could store an email address for the expert) and whenever a provisional optimized fault tree is created the expert is notified by email.

At step 220, the subject matter expert accesses the diagnostic tree editor 130 and selects the particular provisional optimized fault tree that was just created by the comparison engine 100. At step 222, the expert then reviews the fault tree and assesses subjectively the proposed changes to the fault tree proposed by the comparison engine. The subject matter expert could edit and revise the fault tree (using simple word processing techniques), could accept the proposed fault tree, or reject it. At step 224, if the expert edits the fault tree and accepts it or accepts it without any changes, the provisional fault tree is stored in memory as an optimized fault tree. Although not shown in FIG. 5 or 6B, the process continues with dissemination of the optimized fault tree, either though printed manuals distributed to the repair shops 20/36, through email updates, technical service bulletins, monthly update disks mailed to the shops, or though some other format or mechanism, the details of which are not pertinent.

As shown in FIG. 6B, the process continues with the processing looping back to step 210 and repeating the steps 210-224 on a periodic basis. As noted above, this process will typically be performed in parallel simultaneously for other fault trees or other diagnostic aids for the given machine and for any other machines of interest to the host system.

Insofar as the embodiments described herein may include or be utilized in machines taking the form of vehicles or engines for vehicles, they may be used with any appropriate voltage or current source, such as a battery, an alternator, a fuel cell, and the like, providing any appropriate current and/or voltage, such as about 12 Volts, about 42 Volts and the like. The embodiments described herein may be used with any desired system or engine. Those systems or engines may be comprised of items utilizing fossil fuels, such as gasoline, natural gas, propane and the like, electricity, such as that generated by battery, magneto, fuel cell, solar cell and the like, wind and hybrids or combinations thereof. Those systems or engines may be incorporated into other systems, such as an automobile, a truck, a boat or ship, a motorcycle, a generator, an airplane and the like.

Furthermore, the disclosure is applicable to diagnostic aids and machines generally and is not limited to any particular field of application.

Variation from the particulars of the disclosed embodiments is contemplated. For example, the form of the diagnostic aid is not particularly important. The nature of the service occasions, the service data stored in the database, the host system and the nature of the machine, the service or the repair in question (exhaust, brakes, ignition, wheel alignment, etc.) will depend on the machine the fault tree is designed for and the details are not critical. The design of the host system (and possible incorporation of the database 12 into the workstation or processing entity 14) is not important. In a situation where nodes of a fault tree are ranked with confidence scores or equivalent rankings, the rankings could be in the form of an index such as “high”, “very high”, “medium”, or on some other numerical scale such as 1 to 10, 1 to 5, 0 to 1, or otherwise. Questions of scope of this patent are to be determined by reference to the appended claims and legal equivalents thereof.

We claim:

1. A system for improving a diagnostic tool for aiding in machine diagnostics, comprising:
a plurality of distributed data collection devices adapted for collecting data from a plurality of distributed machines;
a central data analysis computing unit performing at least one processing operation on the data received from the plurality of distributed data collection devices and generating at least one proposed modification to the diagnostic tool based on the data;
a diagnostic tool editor comprising a set of instructions executable by a programmed machine, the editor comprising a set of instructions allowing a user to (a) view the at least one proposed modification to the diagnostic tool and (b) selectively accept, modify or reject the proposed change.

2. The system of claim 1, wherein the diagnostic tool comprises a diagnostic aid capable of being represented in a graphical form and wherein the central data analysis computing unit proposed a modification to the diagnostic aid.

3. The system of claim 2, wherein the graphical aid comprises an aid selected from the following group of aids: a diagnostic fault tree, a troubleshooting guide, and a repair guide.

4. The system of claim 1, wherein the plurality of distributed data collection devices are adapted to gather data from an engine of a motor vehicle.

5. The system of claim 4, wherein the plurality of distributed data collection devices further comprise an interface for connecting the devices to a communications network for transmitting the data to the central data analysis computing unit.

6. The system of claim 1, wherein the central data analysis computing unit processes the data to generate confidence scores for nodes in a diagnostic fault tree and generates a proposed revised diagnostic fault tree based on the confidence scores.

7. The system of claim 1, wherein the central data analysis computing unit includes a processor that executes the set of instructions forming the diagnostic tool editor.

8. The system of claim 1, wherein the central data analysis computing unit is programmed to perform the at least one processing operation on a periodic basis and responsively generate at least one proposed modification to the diagnostic tool based on the data on a periodic basis.

9. The system of claim 1, further comprising a central database coupled to the central data analysis unit storing data received from the plurality of distributed machines, wherein the data comprises diagnostic data.

10. Apparatus for improving a diagnostic tool for aiding in machine diagnostics, comprising:
a central data analysis computing unit performing at least one processing operation on machine diagnostic data received from a plurality of distributed data collection devices; the central data analysis computing unit programmed to generating at least one proposed modification to the diagnostic tool based on the data;
a diagnostic tool editor comprising a set of instructions executable by a programmed machine, the editor comprising a set of instructions allowing a user to (a) view the at least one proposed modification to the diagnostic tool and (b) selectively accept, modify or reject the proposed change.

11. The apparatus of claim 10, wherein the diagnostic tool comprises a diagnostic aid capable of being represented in a graphical form and wherein the central data analysis computing unit proposed a modification to the diagnostic aid.

12. The apparatus of claim 11, wherein the graphical aid comprises an aid selected from the following group of aids: a diagnostic fault tree, a troubleshooting guide, and a repair guide.

13. The apparatus of claim 10, wherein the plurality of distributed data collection devices are adapted to gather data from an engine of a motor vehicle.

14. The apparatus of claim 13, wherein the plurality of distributed data collection devices further comprise an interface for connecting the devices to a communications network for transmitting the data to the central data analysis computing unit.

15. The apparatus of claim 10, wherein the central data analysis computing unit processes the data to generate confidence scores for nodes in a diagnostic fault tree and generates a proposed revised diagnostic fault tree based on the confidence scores.

16. The apparatus of claim 10, wherein the central data analysis computing unit includes a processor that executes the set of instructions forming the diagnostic tool editor.

17. The apparatus of claim 10, wherein the central data analysis computing unit is programmed to perform the at least one processing operation on a periodic basis and responsively generate at least one proposed modification to the diagnostic tool based on the data on a periodic basis.

18. The apparatus of claim 10, further comprising a central database coupled to the central data analysis unit storing data received from the plurality of distributed machines, wherein the data comprises diagnostic data.

19. A method for updating a diagnostic tool for aiding in machine diagnostics, comprising:
receiving diagnostic session data from a plurality of distributed data collection devices and storing the diagnostic session data in a memory; processing the diagnostic session data with a programmed machine and responsively generating a proposed modification to the diagnostic tool based on the diagnostic session data;
providing a diagnostic tool editor, wherein the editor is programmed to present the diagnostic tool to a user and allow the user the interactively accept, modify or reject the proposed modification.

20. The method of claim 19, wherein the diagnostic tool comprises a diagnostic aid capable of being represented in a graphical form.

21. The method of claim 20, wherein the graphical aid comprises an aid selected from the following group of aids: a diagnostic fault tree, a troubleshooting guide, and a repair guide.

22. The method of claim 21, wherein the diagnostic session data comprises session data gathered from a motor vehicle.

23. The method of claim 22, wherein the plurality of distributed data collection devices further comprise an interface for connecting the devices to a communications network for transmitting the data for storage in the memory, wherein the central data analysis computing unit performs the processing step.

24. The method of claim 19, wherein the processing step comprises the step of generating confidence scores for nodes in a diagnostic fault tree, and wherein the editor displays a proposed revised diagnostic fault tree to the user based on the confidence scores.

25. The method of claim 19, wherein the processing step is performed on a periodic basis and wherein at least one proposed modification to the diagnostic tool based on the data is made on a periodic basis.
